(19) United States
(12) Patent Application Publication
(10) Pub. No.: US 2022/0099045 A1
(43) Pub. Date: Mar. 31, 2022

(54) Method and Device for Pressure Regulation in a Fuel Hight-Pressure Injection System

(71) Applicant: Vitesco Technologies GmbH, Regensburg (DE)

(72) Inventors: Michael Wirkowski, Regensburg (DE); Walter Sassler, Regensburg (DE); Jan Kempinger, Regensburg (DE)

(73) Assignee: Vitesco Technologies GmbH, Regensburg (DE)

(21) Appl. No.: 17/644,002

(22) Filed: Dec. 13, 2021

Related U.S. Application Data
(63) Continuation of application No. PCT/EP2020/068454, filed on Jul. 1, 2020.

(30) Foreign Application Priority Data
Jul. 3, 2019 (DE) 10 2019 209 796.0

(51) Int. Cl. F02D 41/38

(52) U.S. Cl. CPC F02D 41/3845; F02D 2200/101; F02D 2200/0602

(57) ABSTRACT

The disclosure relates to a method for pressure regulation in a fuel high-pressure injection system having an overpressure valve, in which pressure pulsations occur which are caused by fuel being pumped into a high-pressure fuel accumulator and extracted from the high-pressure fuel accumulator. The method includes detecting pressure values of the fuel present in the high-pressure fuel accumulator. The method also includes comparing the detected pressure values with a nominal pressure value; and carrying out a pressure regulation in which the fuel pressure prevailing in the high-pressure fuel accumulator is set to the nominal pressure value. During pressure regulation, a peak pressure value of the detected pressure values is used as the actual pressure value. The disclosure also relates to a device for pressure regulation in a fuel high-pressure injection system.

### CROSS-REFERENCE TO RELATED APPLICATIONS

This application claims the benefit of PCT Application PCT/EP2020/068454, filed Jul. 1, 2020, which claims priority to German Application DE 10 2019 209 796.0, filed Jul. 3, 2019. The disclosures of the above applications are incorporated herein by reference.

### TECHNICAL FIELD

The disclosure relates to a method and a device for pressure regulation in a fuel high-pressure injection system.

### BACKGROUND

In fuel high-pressure injection systems for internal combustion engines, fuel for injection into a combustion chamber is provided from a high-pressure fuel accumulator which is arranged upstream of the fuel injection valves of the internal combustion engine. The high pressure required in the high-pressure fuel accumulator is generated by pumping the fuel by way of a high-pressure fuel pump. This pumping of fuel leads to a pressure rise in the high-pressure fuel accumulator. For injection of fuel into a respective combustion chamber of the internal combustion engine, fuel is taken from the high-pressure fuel accumulator and injected into the respective combustion chamber by the fuel injection valves (fuel injectors). These injection processes cause a pressure fall in the high-pressure fuel accumulator. Pressure pulsations occur due to the pumping of the fuel into the high-pressure fuel accumulator and the injection of the fuel taken from the high-pressure fuel accumulator.

Fuel high-pressure injection systems usually have an overpressure valve connected to the high-pressure fuel accumulator. The purpose of this is to limit a pressure rise in the high-pressure fuel accumulator which may be caused by a malfunction. If such a malfunction occurs in these fuel high-pressure injection systems, the overpressure valve opens so that fuel can be returned from the high-pressure fuel accumulator through the overpressure valve and a fuel return line to the fuel tank for example. Furthermore, the overpressure valve prevents an excessive pressure rise in the high-pressure fuel accumulator caused by waste engine heat. In the design of the fuel high-pressure injection system, the opening pressure of the overpressure valve must be set to such a high pressure value that the overpressure valve does not open under the above-mentioned pulsations occurring in normal operation of the fuel high-pressure injection system.

This design must take into account maximum values occurring in normal operation, for example taking into account very high rotation speeds, very high and very low exterior temperatures, maximum permitted injection masses, and the respective dimensions of the high-pressure fuel accumulator. Because of the need to design the fuel high-pressure injection system taking into account maximum values occurring in normal operation, the opening pressure of the overpressure valve must be set to a very high pressure value. This is associated with disadvantages. For example, the high pressure rise caused by waste engine heat may be very high. Therefore, the fuel injectors must also be able to perform injections under such a high pressure. This requires the use of comparatively costly fuel injectors, and furthermore leads to a conflict of objectives with respect to injection precision for small injection masses. Furthermore, the electrically actuating engine control unit used must provide a comparatively high energy level. This leads to higher costs and entails further disadvantages.

Furthermore, in the known methods for pressure regulation in a fuel high-pressure injection system, pressure regulation is carried out using a controller which regulates the mean pressure. A P-I controller (proportional-integral controller) which regulates the mean pressure cannot influence the peak pressure height of the pressure pulsation.

### SUMMARY

The disclosure specifies a method and a device in which the above-mentioned disadvantages do not occur.

One aspect of the disclosure provides a method for pressure regulation in a fuel high-pressure injection system having an overpressure valve, in which pressure pulsations occur which are caused by fuel being pumped into a high-pressure fuel accumulator and extracted from the high-pressure fuel accumulator. The method includes detecting pressure values of the fuel present in the high-pressure fuel accumulator, and comparing the detected pressure values with a nominal pressure value. The method also includes carrying out a pressure regulation in which the fuel pressure prevailing in the high-pressure fuel accumulator is set to the nominal pressure value. During pressure regulation, a peak pressure value of the detected pressure values is used as the actual pressure value.

The advantages of the disclosure are that all parameters which could have a negative effect on the height of the pressure pulsation are no longer decisive for the pressure peaks actually occurring in normal operation. The fuel high-pressure injection system can advantageously be designed for the nominal pressure. The opening pressure of the overpressure valve can suitably be set accordingly.

A further advantage of the disclosure is that aliasing effects, which occur at very high engine rotation speeds in known methods, can be reduced or completely prevented.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 a block diagram of a fuel high-pressure injection system.

FIG. 2 a diagram to illustrate a known pressure regulation in a fuel high-pressure injection system.

FIG. 3 a diagram to illustrate an exemplary pressure regulation in a fuel high-pressure injection system.

FIG. 4 a block diagram to illustrate an exemplary function method of a controller.

FIG. 5 a diagram to illustrate an exemplary determination of a peak pressure value used for regulation.

Like reference symbols in the various drawings indicate like elements.

### DETAILED DESCRIPTION

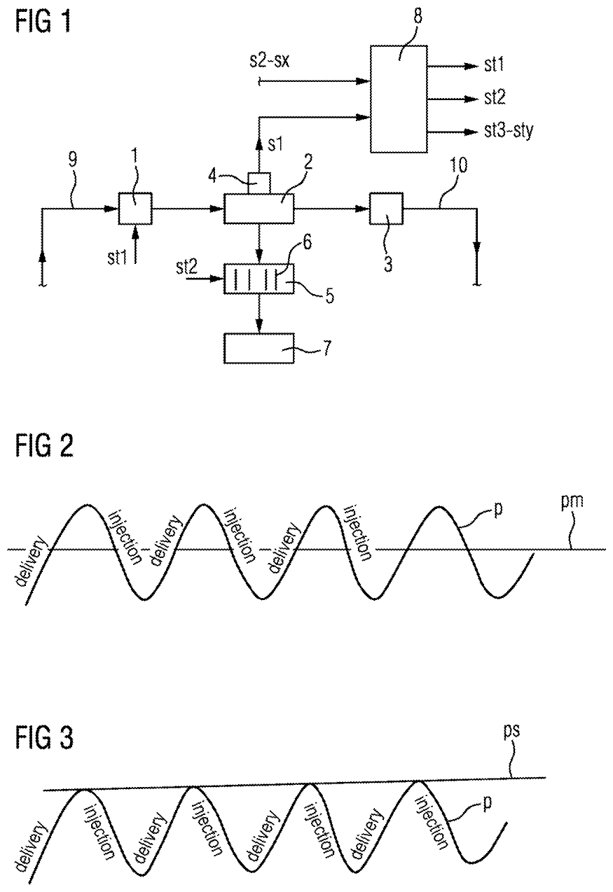

FIG. 1 shows a block diagram of a fuel high-pressure injection system in which a pressure regulation method according to the disclosure may be used.

In this fuel high-pressure injection system, fuel is provided from a fuel tank (not shown) and supplied via a fuel supply line 9 to a high-pressure pump unit 1. By a high-pressure pump belonging to this high-pressure pump unit 1, the fuel is brought to a high pressure and then delivered to a high-pressure fuel accumulator 2. The high-pressure fuel present in this high-pressure fuel accumulator 2 is extracted from the high-pressure fuel accumulator 2 for the performance of injection processes, and supplied to an injector device which includes a plurality of injectors 6. The injectors 6 inject the fuel into combustion chambers 7 of a respective motor vehicle.

The high-pressure pump unit 1 receives control signals st1 from a controller 8 for controlling the operation of the high-pressure pump. The injector device 5 receives control signals st2 from the controller 8 for controlling the injection processes carried out by the injectors 6.

The controller 8 determines the control signals st1 and st2 and further control signals st3—sty using sensor signals s1 and further sensor signals s2—sx and using stored software. The sensor signals s1 are pressure signals provided by a high-pressure sensor 4 which provide information on the pressure of the fuel stored in the high-pressure fuel accumulator 2. The further sensor signals are for example output signals from a rotation speed sensor giving information on the engine rotation speed, and output signals from temperature sensors giving information on temperatures measured at various locations in the engine. Further input signals supplied to the controller 8 are for example signals giving information on the type of fuel present in the tank of the motor vehicle, signals giving information on the size of the high-pressure fuel accumulator used, and signals giving information on any superposition of the pump delivery with the injection.

An overpressure valve 3, having a predefined opening pressure, is connected to the high-pressure fuel accumulator 2. If the pressure of the fuel present in the high-pressure fuel accumulator 2 exceeds the opening pressure of the overpressure valve 3, this opens and conducts fuel from the high-pressure fuel accumulator 2 via a fuel return line 10 back into the fuel tank (not shown).

The fuel high-pressure injection system shown in FIG. 1 is a common rail diesel injection system. Alternatively, the fuel high-pressure injection system may also be a high-pressure petrol injection system. In this case, the overpressure valve is an integral part of the high-pressure pump unit 1.

In conventional methods for pressure regulation in a fuel high-pressure injection system having an overpressure valve, the fuel pressure in the high-pressure fuel accumulator 2 is regulated by a controller which sets a mean pressure of the fuel to a predefined nominal value for each pump stroke. In this regulation process, the high-pressure signal is sampled with a sampling frequency of 1 kHz and then averaged in order to determine a mean actual pressure value. This procedure is illustrated in FIG. 2, which shows the development of the pressure signal p and the mean pressure value pm. FIG. 2 furthermore shows that the curve of the pressure signal p has rising and falling flanks which as a whole constitute a pressure pulsation. The flanks designated with the word “Delivery” correspond to the pumping of fuel into the high-pressure fuel accumulator 2, where the pressure in the high-pressure fuel accumulator 2 is increased, and the falling flanks designated with the word “Injection” correspond to an extraction of fuel from the high-pressure fuel accumulator 2, which causes the pressure in the high-pressure fuel accumulator 2 to fall again.

In a method according to the disclosure for pressure regulation in a fuel high-pressure injection system having an overpressure valve, in contrast to the procedure explained with reference to FIG. 2, the fuel pressure in the high-pressure fuel accumulator 2 is regulated by a controller which uses a peak pressure value of the detected pressure values as an actual pressure value. This procedure is illustrated in FIG. 3, which shows the development of the pressure signal p and the development of the peak pressure value ps. FIG. 3 furthermore shows that the curve of the pressure signal has rising and falling flanks which as a whole constitute a pressure pulsation. The flanks designated with the word “Delivery” correspond to the pumping of fuel into the high-pressure fuel accumulator 2, where the pressure in the high-pressure fuel accumulator 2 is increased, and the falling flanks designated with the word “Injection” correspond to an extraction of fuel from the high-pressure fuel accumulator 2, which causes the pressure in the high-pressure fuel accumulator 2 to fall again.

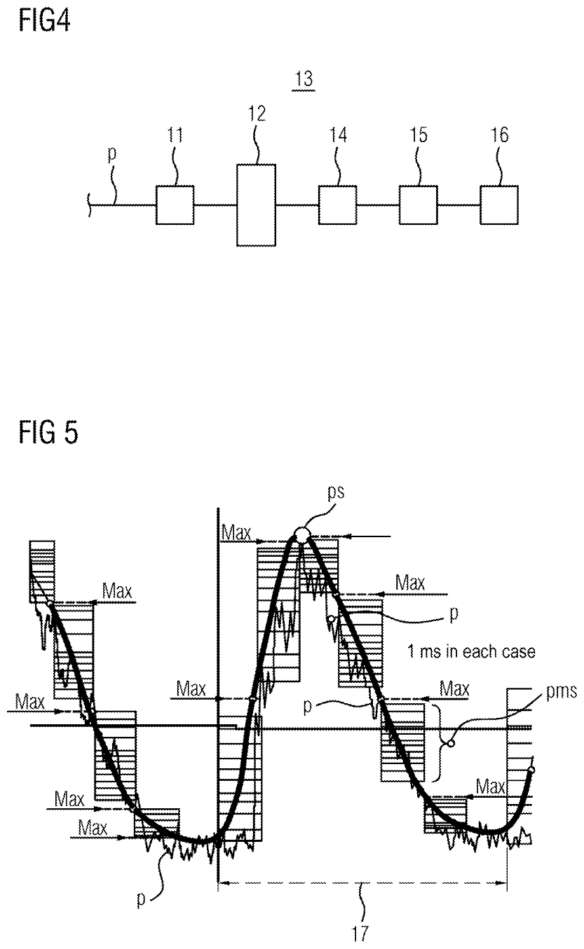

FIG. 4 shows a block diagram to illustrate the function method of a controller which is configured to control a method according to the disclosure.

This controller includes a pressure value acquisition in which a significantly higher sampling frequency is used for sampling the pressure signal. In the example shown, the pressure signals p present at the input and provided by the high-pressure sensor 4 are sampled in an A/D converter 11 with a sampling frequency of 16 kHz, so that 16 pressure values are present per millisecond.

These pressure values are read into a buffer memory 12 which for example has 32 memory locations.

Every millisecond, the 16 pressure values are output from this buffer memory to a processing software 13 and processed further there. In the context of this further processing, if required a digital filtering may be performed using a digital filter 14, the purpose of which is to damp or filter out any disruptive components in the output signal from the buffer memory. These disruptive components may for example be higher frequency components which lie outside the range concerned for the application, e.g. 1 kHz.

The signals output from the buffer memory 12 or digital filter 14 are supplied to a peak pressure value determinator 15. In this peak pressure value determinator 15, for each engine segment 17, a peak pressure value ps is determined from the signals present within this engine segment and supplied to the controller 16, which uses this as an actual pressure value for the regulation process in the respective following engine segment. In this regulation process, the controller compares the provided actual pressure value with a predefined, empirically determined nominal pressure value or one predefined by the vehicle manufacturer, and sets the pressure in the high-pressure fuel accumulator 2 to the predefined nominal pressure value. To this end, the controller generates control signals st1 which are supplied to the pump unit 1 shown in FIG. 1 so that a greater or lesser quantity of fuel is pumped into the high-pressure fuel accumulator 2, depending on requirements.

FIG. 5 shows a diagram illustrating in more detail the determination of a peak pressure value used for regulation.

FIG. 5 shows the development of the analog pressure signal p which corresponds to the pressure prevailing in the high-pressure fuel accumulator 2. This pressure signal p is sampled in the A/D converter 11, shown in FIG. 3, with a sampling frequency of 16 kHz, so that in total 16 pressure values are provided per millisecond. These 16 pressure values are depicted in a rectangular box for each millisecond and are stored in the buffer memory 12. One of these boxes in FIG. 5 is marked with reference sign pms, where pms designates all 16 pressure values present in this millisecond. One of these 16 pressure values is a maximum pressure value in this millisecond, where after transfer of the pressure values temporarily stored in the buffer memory 12 to the peak pressure value determinator 15, this maximum pressure value is determined in the peak pressure value determinator 15. This maximum pressure value of this millisecond is designated with the reference sign Max. In each of the further rectangular boxes shown in FIG. 5, again 16 pressure values are depicted which correspond to the pressure values present in the respective millisecond, of which again one of these is the maximum pressure value Max for the respective associated millisecond.

FIG. 5 furthermore illustrates an engine segment 17. An engine segment corresponds to the interval between the top dead centre of an injector and the next top dead centre of the injector. In the example shown, this engine segment has a segment time amounting to 7 milliseconds. This segment time varies with the rotation speed of the internal combustion engine which, in the example shown, is 4285 revolutions per minute.

As a peak pressure value ps for the engine segment 17 shown in FIG. 5, the peak pressure determinator 15 determines the maximum value Max which has the highest pressure value. This is designated in FIG. 5 with reference sign ps, and is transmitted by the peak pressure determinator 15 to the controller 16 which uses this pressure value in the regulation process as an actual pressure value ps for the following engine segment.

In the example described above, all pressure values provided by the A/D converter are used in determination of the peak pressure value for a respective engine segment. In alternative examples, not all pressure values provided by the A/D converter are used in determination of the peak pressure value for a respective engine segment, but for example only every second, third or fourth pressure value. The number of pressure values used may be selected depending on the engine rotation speed such that always a predefined minimum number of pressure values are present per engine segment. By such a reduction in the number of pressure values used for determining a peak pressure value, the sampling frequency required to determine a respective peak pressure value can be adapted according to the pulsation frequency occurring, in order e.g. to exclude aliasing effects and keep the required buffer size within limits.

In the present disclosure, overall, the mean pressure value is not set to a nominal value, and the opening pressure of the overpressure valve is not dimensioned for a pressure peak occurring in the worst case scenario; rather, a peak pressure value in each engine segment is set to a nominal value, and the opening pressure of the overpressure valve is set to a value which does not lead to opening of the overpressure valve in the presence of an operating point occurring in normal operation. The pulsations occurring in operation are thus included in the regulation, such that the maximum pressure does not exceed the nominal pressure.

A number of implementations have been described. Nevertheless, it will be understood that various modifications may be made without departing from the spirit and scope of the disclosure. Accordingly, other implementations are within the scope of the following claims.

What is claimed is:

1. A method for pressure regulation in a fuel high-pressure injection system having an overpressure valve, in which pressure pulsations occur which are caused by fuel being pumped into a high-pressure fuel accumulator and extracted from the high-pressure fuel accumulator, the method having the following steps:
detecting pressure values of the fuel present in the high-pressure fuel accumulator;
comparing the detected pressure values with a nominal pressure value; and
carrying out a pressure regulation in which the fuel pressure prevailing in the high-pressure fuel accumulator is set to the nominal pressure value;
wherein during pressure regulation, a peak pressure value of the detected pressure values is used as the actual pressure value.

2. The method of claim 1, wherein the peak pressure value is determined for each engine segment and used as an actual pressure value for the following engine segment.

3. The method of claim 2, wherein an engine segment has a segment duration of several milliseconds.

4. The method of claim 3, wherein several pressure values are detected per millisecond.

5. The method of claim 1, wherein the detected pressure values are written to a buffer memory.

6. The method of claim 5, wherein the pressure values stored in the buffer memory are read from the buffer memory and processed further by a processing software.

7. The method of claim 6, wherein only some of the pressure values detected per millisecond are processed further by the processing software.

8. The method of claim 7, wherein a number of pressure values processed further by the processing software depends on an engine rotation speed.

9. The method of claim 6, wherein the processing software determines a maximum pressure value from the pressure values detected for each millisecond of an engine segment, and determines the peak pressure value for this engine segment from all maximum pressure values of this engine segment.

10. The method of claim 1, wherein an opening pressure of the overpressure valve is set to an empirically determined constant pressure value which is greater than the determined peak pressure value in normal operating mode of the fuel high-pressure injection system.

11. A device for pressure regulation in a fuel high-pressure injection system having an overpressure valve and a controller for regulating a fuel pressure in the high-pressure injection system, the controller configured to perform the following steps:
detect pressure values of fuel present in a high-pressure fuel accumulator;
compare the detected pressure values with a nominal pressure value; and
carrying out a pressure regulation in which the fuel pressure prevailing in the high-pressure fuel accumulator is set to the nominal pressure value;
wherein during pressure regulation, a peak pressure value of the detected pressure values is used as the actual pressure value.

12. The device of claim 11, wherein the overpressure valve is arranged in a high-pressure pump unit.

13. The device of claim 11, wherein the overpressure valve is connected to the high-pressure fuel accumulator.

14. The device of claim 11, wherein the controller further performs:
determining a peak pressure value for each engine segment and used as an actual pressure value for the following engine segment.

15. The device of claim 14, wherein an engine segment has a segment duration of several milliseconds.

16. The device of claim 15, wherein the controller further performs: several pressure values are detected per millisecond.

17. The device of claim 11, wherein the controller further performs: detecting pressure values are written to a buffer memory.

18. The device of claim 11, wherein an opening pressure of the overpressure valve is set to an empirically determined constant pressure value which is greater than the determined peak pressure value in normal operating mode of the fuel high-pressure injection system.
